(19) United States
(12) Patent Application Publication
(10) Pub. No.: US 2026/0145161 A1
(43) Pub. Date: May 28, 2026

(54) CATALYTIC COMPOSITION AND METHOD FOR REMOVING NITROGEN OXIDES

(71) Applicant: Industrial Technology Research Institute, Hsinchu (TW)

(72) Inventors: Chuan-Lin Chang, Taichung City (TW); Hong-Ping Lin, Taipei City (TW); Min-Jia Xie, Nantou County (TW)

(73) Assignee: Industrial Technology Research Institute, Hsinchu (TW)

(21) Appl. No.: 19/051,033

(22) Filed: Feb. 11, 2025

(30) Foreign Application Priority Data
Nov. 26, 2024 (TW) 113145444

(51) Int. Cl. B01J 23/34; B01D 53/86; B01J 23/42; B01J 23/44; B01J 23/72; B01J 23/755; B01J 35/40; B01J 35/61

(52) U.S. Cl. CPC B01J 23/34; B01D 53/8628; B01J 23/42; B01J 23/44; B01J 23/72; B01J 23/755; B01J 35/40; B01J 35/615; B01D 2257/40; B01J 2523/12; B01J 2523/13; B01J 2523/17; B01J 2523/72; B01J 2523/847

(57) ABSTRACT

A catalytic composition, including a carrier, a first active component, and a second active component. The first active component is covered on a surface of the carrier. The first active component includes a first catalyst, and the first catalyst is a manganese oxide. The second active component includes a second catalyst and a third catalyst, and is covered on a surface of the first active component and the surface of the carrier that is uncovered with the first active component. The second catalyst includes a platinum metal, a palladium metal, or a combination thereof. The third catalyst includes a potassium oxide, a sodium oxide, or a combination thereof. A molar ratio of the first catalyst to the second catalyst is from 1:0.001 to 1:0.2, and a molar ratio of the first catalyst to the third catalyst is from 1:0.1 to 1:10.

### CROSS-REFERENCE TO RELATED APPLICATION

This application claims the priority benefit of Taiwan application serial no. 113145444, filed on Nov. 26, 2024. The entirety of the above-mentioned patent application is hereby incorporated by reference herein and made a part of this specification.

### TECHNICAL FIELD

The disclosure relates to a catalytic composition and a method for removing nitrogen oxides.

### BACKGROUND

Nitrogen in the air reacts with oxygen after high-temperature combustion (>800° C.) to produce nitrogen oxides (NO_{X}). These pollutants cause problems such as acid rain, photochemical smog, ozone layer depletion, and eutrophication. Therefore, reducing NO_{X} emissions is critical for environmental protection. Currently, the globally mature and mainstream method for NO_{X} removal is selective catalytic reduction with ammonia (NH₃-SCR).

However, the NH₃-SCR technology encounters issues such as heater fouling and catalyst degradation during use. Therefore, there is an urgent need to develop other technologies for NO_{X} removal and improve destruction and removal efficiency.

### SUMMARY

A catalytic composition of the disclosure includes a carrier, a first active component, and a second active component. The first active component is covered on a surface of the carrier. The first active component includes a first catalyst, and the first catalyst is a manganese oxide. The second active component includes a second catalyst and a third catalyst, and is covered on a surface of the first active component and on a surface of the carrier uncovered with the first active component. The second catalyst includes a platinum metal, a palladium metal, or a combination thereof, and the third catalyst includes a potassium oxide, a sodium oxide, or a combination thereof. A molar ratio of the first catalyst to the second catalyst is from 1:0.001 to 1:0.2, and a molar ratio of the first catalyst to the third catalyst is from 1:0.1 to 1:10.

A method for removing nitrogen oxides of the disclosure includes the following step. A selective catalytic reduction with a hydrogen (abbreviated as H₂-SCR) is performed on the nitrogen oxides using the catalytic composition.

To make the disclosure more comprehensible, several embodiments accompanied with drawings are described in detail as follows.

### BRIEF DESCRIPTION OF THE DRAWINGS

FIG. 1 is a schematic diagram of a catalytic composition according to a first embodiment of the disclosure.

FIG. 2 is a schematic diagram of a catalytic composition according to a second embodiment of the disclosure.

FIG. 3 is a block diagram of an equipment used in an experimental example for removing nitrogen oxides.

### DETAILED DESCRIPTION OF DISCLOSED EMBODIMENTS

The embodiments are described in detail below with reference to the accompanying drawings, but the embodiments are not intended to limit the scope of the disclosure. In addition, the drawings are specifically for illustrative purposes and are not drawn to the original dimensions. For the sake of easy understanding, the same elements in the following description will be denoted by the same reference numerals.

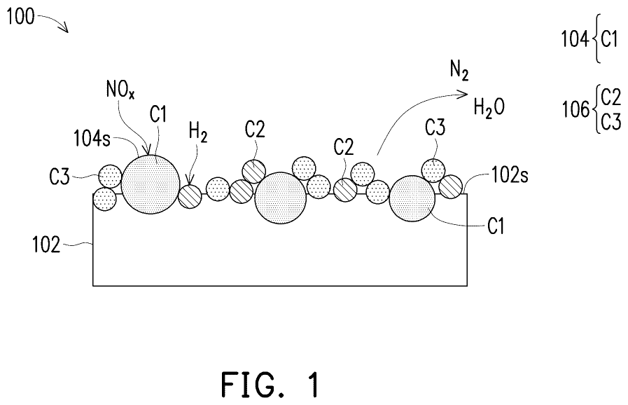

FIG. 1 is a schematic diagram of a catalytic composition according to a first embodiment of the disclosure.

Referring to FIG. 1, a catalytic composition 100 of the first embodiment includes a carrier 102, a first active component 104, and a second active component 106. In some embodiments, the carrier 102 includes aluminum oxide, titanium oxide, zirconium oxide, cerium oxide, magnesium oxide, or a combination thereof. The first active component 104 is covered on a surface 102s of the carrier 102, wherein the first active component 104 includes a first catalyst C1, and the first catalyst C1 is manganese oxide. The first active component 104 may partially or fully cover the surface of the carrier 102. The second active component 106 includes a second catalyst C2 and a third catalyst C3, and may cover a surface 104s of the first active component 104 and a surface 102s of the carrier 102 uncovered with the first active component 104. The second catalyst C2 includes a platinum metal, a palladium metal, or a combination thereof, and the third catalyst C3 includes a potassium oxide, a sodium oxide, or a combination thereof.

A molar ratio of the first catalyst C1 to the second catalyst C2 is from 1:0.001 to 1:0.2, for example, from 1:0.001 to 1:0.1 or from 1:0.001 to 1:0.02. A molar ratio of the first catalyst C1 to the third catalyst C3 is from 1:0.1 to 1:10, for example, from 1:0.1 to 1:5 or from 1:0.1 to 1:2. In some embodiments, a molar ratio of the first catalyst C1 to the carrier 102 is from 1:3 to 1:20.

In some embodiments, a specific surface area (BET) of the catalytic composition 100 may be from 140 m² g⁻¹ to 500 m² g⁻¹, for example, from 160 m² g⁻¹ to 400 m² g⁻¹ or from 170 m² g⁻¹ to 300 m² g⁻¹. In some embodiments, a particle size of the catalytic composition 100 may be from 100 μm to 10 mm, for example, from 500 μm to 10 mm or from 1 mm to 10 mm, but is not limited thereto.

In FIG. 1, the first catalyst C1 in the first active component 104 is used to adsorb nitrogen oxides (NO_{X}), and hydrogen (H₂) is used as a reducing agent. The second catalyst C2 in the second active component 106 adsorbs H₂ and dissociates it into hydrogen free radicals (hydrogen atoms). The adsorbed nitrogen oxides (NO_{X}) undergo nitrogen-oxygen bond cleavage due to the strong reducing nature of the hydrogen free radicals, producing nitrogen gas (N₂) and water (H₂O) as reaction products. The third catalyst C3 adjusts properties such as the activity and acidity/basicity of the catalytic composition 100. Therefore, the catalytic composition 100 of this embodiment not just reduces pollutant emissions but also promotes the application of hydrogen energy in the energy structure, advancing sustainable development.

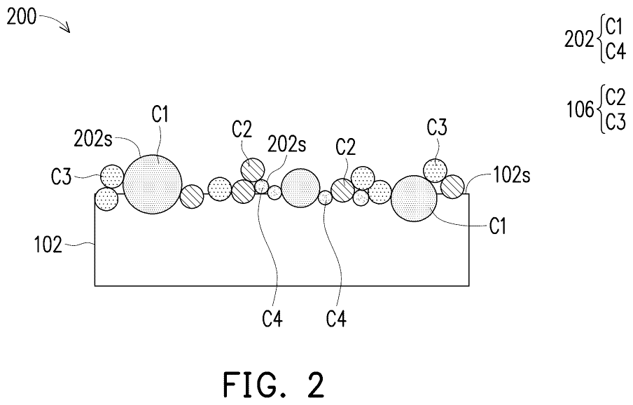

FIG. 2 is a schematic diagram of a catalytic composition according to a second embodiment of the disclosure. The same reference symbols as those in the first embodiment are used to represent the same or similar parts, structures, or dimensions in FIG. 2. The descriptions of the same parts, structures, or dimensions may be referred to in the relevant explanations of the first embodiment and will not be redundantly detailed here.

In FIG. 2, the difference between the second embodiment and the first embodiment lies in a first active component 202 of a catalytic composition 200, which further includes a fourth catalyst C4. Thus, the first active component 202 contains the first catalyst C1 and the fourth catalyst C4. The fourth catalyst C4 includes copper oxide, nickel oxide, or a combination thereof, and is formed together with the first catalyst C1 on the surface 102s of the carrier 102. In other words, the first catalyst C1 and the fourth catalyst C4 are cover the surface 102s of the carrier 102, while the second catalyst C2 and the third catalyst C3 in the second active component 106 may cover the surface 202s of the first active component 202 and the surface 102s of the carrier 102 that is uncovered with the first active component 202. The fourth catalyst C4 improves the dispersion of the first active component 202 and suppresses side reactions. In some embodiments, a molar ratio of the first catalyst C1 to the fourth catalyst C4 is from 1:0.01 to 1:10, for example, from 1:0.01 to 1:5 or from 1:0.01 to 1:2.

The disclosed catalytic composition may be used to treat process gases or exhaust gases containing NO_{X}, such as those from electronics factories, power plants, incinerators, glass factories, cement factories, and refineries. The catalytic composition may be used alone, for example, by filling the catalytic composition into a column so that the gas to be treated flows through the column to achieve destruction and removal. Alternatively, the catalytic composition may be combined with certain carriers, for example, by disposing the catalytic composition on the surfaces or within the structures of the carriers, and placing them in a chamber or container so that the gas to be treated flows through the chamber or container to achieve destruction and removal.

In a third embodiment of the disclosure, a method for removing nitrogen oxides is provided. The method includes performing selective catalytic reduction with hydrogen (H₂-SCR) on nitrogen oxides (NO_{X}) using the catalytic composition 100 or 200 of the embodiments.

In the third embodiment, the removal rate of nitrogen oxides may reach more than 90%, for example, more than 95% or more than 98%.

In the third embodiment, the selective catalytic reduction with hydrogen may be performed at a temperature from 100° C. to 250° C., but is not limited thereto. In other embodiments, the selective catalytic reduction with hydrogen may be performed at a higher temperature, such as from 250° C. to 300° C.

The following experiments are provided to verify the effects of the embodiments of the disclosure, but the disclosure is not limited to the following content.

The following preparation examples (including comparative preparation examples) primarily use a hot water granulation process to introduce active components into a carrier, followed by high-temperature calcination to form the catalytic composition. Compared with catalytic powders that have not undergone a granulation process and are directly calcined at high temperatures after hydrothermal drying, the catalytic compositions prepared according to the preparation examples of the disclosure have more uniform and consistent particle sizes. These compositions may be produced in specific sizes conducive to stacking and suitable for industrial operations, while also being less prone to generating dust. They are particularly suitable for environments requiring dust suppression, such as semiconductor factories.

First, the following preparation examples (including comparative preparation examples) used aluminum oxide as the carrier. Basically, the carrier had to be able to bind with the metal ions to be introduced and had a sufficiently large specific surface area. The aluminum oxide used in the preparation examples had a specific surface area of 373 m² g⁻¹.

### Preparation Example 1

In Preparation Example 1, a colloidal solution was prepared, with a weight ratio of the carrier, sodium alginate powder, and water in the colloidal solution being 20:3:200. The colloidal solution was then added to a hot aqueous solution containing divalent manganese ions (approximately 40 to 90° C.) to form particles containing a first active component, wherein a concentration of the divalent manganese ions was 30,000 ppm.

Subsequently, a 0.4 M K₂C₂O₄ reducing solution, 0.02 M Pd(NO₃)₂, and the particles containing the first active component were mixed and stirred in a ratio of 8.5:85:18. After drying and calcination at 500° C. for 6 hours, the catalytic composition of Preparation Example 1 was obtained.

### Preparation Example 2

The same method as Preparation Example 1 was used, but the components added to the colloidal solution were changed to a hot aqueous solution containing 25,000 ppm manganese ions and 5,000 ppm nickel ions.

### Preparation Example 3

The same method as Preparation Example 1 was used, but the components added to the colloidal solution were changed to a hot aqueous solution containing 25,000 ppm manganese ions and 5,000 ppm copper ions.

### Preparation Example 4

The same method as Preparation Example 1 was used, but the components added to the colloidal solution were changed to a hot aqueous solution containing 25,000 ppm manganese ions and 5,000 ppm nickel ions, and the reducing solution was changed to Na₃C₆H₅O₇.

### Preparation Example 5

The same method as Preparation Example 4 was used, but the components added to the colloidal solution were changed to a hot aqueous solution containing 25,000 ppm manganese ions and 5,000 ppm copper ions.

### Preparation Example 6

The same method as Preparation Example 1 was used, but Pd(NO₃)₂ was replaced with Pt(NO₃)₂.

### Comparative Preparation Example 1

The same method as Preparation Example 1 was used to obtain particles containing the first active component, which were then directly calcined to obtain a catalytic composition containing just manganese oxide.

### Comparative Preparation Example 2

The same method as Preparation Example 1 was used, but without adding the K₂C₂O₄ reducing solution.

### Comparative Preparation Example 3

The same method as Preparation Example 6 was used, but without adding the K₂C₂O₄ reducing solution.

### Comparative Preparation Example 4

The same method as Preparation Example 2 was used, but the components added to the colloidal solution were changed to a hot aqueous solution containing 25,000 ppm manganese ions and 5,000 ppm iron ions, and the K₂C₂O₄ reducing solution was replaced with Ca₃(C₆H₅O₇)₂.

### Comparative Preparation Example 5

The same method as Preparation Example 5 was used, but the manganese ions added to the colloidal solution were replaced with 25,000 ppm molybdenum ions.

### <Component Analysis>

1. Metal component ratios of the catalytic compositions from Preparation Examples 1 to 6 and Comparative Preparation Examples 1 to 5 were determined using energy dispersive X-ray spectroscopy (EDS) and are recorded in Table 1.

2. Specific surface areas of the catalytic compositions from Preparation Examples 1 to 6 and Comparative Preparation Examples 1 to 5 were measured using a nitrogen adsorption-desorption method (BET method) and are also recorded in Table 1.

TABLE 1

| | C1 | | | C3 | | C4 | | | |
|---|---|---|---|---|---|---|---|---|---|
| | Manganese | C2 | | Potassium | Sodium | Copper | Nickel | | |
| | Oxide | Pt | Pd | Oxide | Oxide | Oxide | Oxide | Carrier | BET |
| Comparative | 19.2 | | | | | | | 80.8 | 233 m² g⁻¹ |
| Preparation | | | | | | | | | |
| Example 1 | | | | | | | | | |
| Preparation | 14.5 | | 0.01 | 5.1 | | | | 80.4 | 222 m² g⁻¹ |
| Example 1 | | | | | | | | | |
| Preparation | 4.6 | | 0.01 | 5.2 | | | 3.2 | 87.0 | 141 m² g⁻¹ |
| Example 2 | | | | | | | | | |
| Preparation | 5.4 | | 0.03 | 6.2 | | 8.8 | | 79.6 | 163 m² g⁻¹ |
| Example 3 | | | | | | | | | |
| Preparation | 4.6 | | 0.06 | | 7.3 | | 5.8 | 82.2 | 143 m² g⁻¹ |
| Example 4 | | | | | | | | | |
| Preparation | 5.5 | | 0.01 | | 5.4 | 7.5 | | 81.6 | 151 m² g⁻¹ |
| Example 5 | | | | | | | | | |
| Preparation | 14.8 | 0.1 | | 4.9 | | | | 80.2 | 219 m² g⁻¹ |
| Example 6 | | | | | | | | | |
| Comparative | 17.4 | | 0.01 | | | | | 82.5 | 225 m² g⁻¹ |
| Preparation | | | | | | | | | |
| Example 2 | | | | | | | | | |
| Comparative | 21.3 | 0.05 | | | | | | 78.6 | 237 m2 g-1 |
| Preparation | | | | | | | | | |
| Example 3 | | | | | | | | | |
| Comparative | 6.9 | | 0.01 | (Calcium | | (Iron | | 79.8 | 142 m² g⁻¹ |
| Preparation | | | | oxide) 2.9 | | oxide) 10.4 | | | |
| Example 4 | | | | | | | | | |
| Comparative | (Molybdenum | | 0.01 | | 4.6 | 4.4 | | 84.3 | 151 m² g⁻¹ |
| Preparation | oxide) 6.7 | | | | | | | | |
| Example 5 | | | | | | | | | |

Component values in Table 1 are all expressed in atomic percentages (at %), and oxides in parentheses represent other catalytic components used in the comparative preparation examples.

Table 2 lists the calculated molar ratios of each catalyst in the catalytic compositions of Preparation Examples 1 to 6 and Comparative Preparation Examples 2 to 5.

TABLE 2

| | Molar Ratio | | | |
|---|---|---|---|---|
| | C1:C2 | C1:C3 | C1:C4 | C1:carrier |
| Preparation Example 1 | 1:0.001 | 1:0.35 | — | 1:5.54 |
| Preparation Example 2 | 1:0.002 | 1:1.13 | 1:0.7 | 1:18.91 |
| Preparation Example 3 | 1:0.006 | 1:1.15 | 1:1.63 | 1:14.74 |
| Preparation Example 4 | 1:0.013 | 1:1.59 | 1:1.26 | 1:17.87 |
| Preparation Example 5 | 1:0.002 | 1:0.98 | 1:1.36 | 1:14.84 |
| Preparation Example 6 | 1:0.007 | 1:0.33 | — | 1:5.42 |
| Comparative | 1:0.001 | — | — | 1:4.74 |
| Preparation Example 2 | | | | |
| Comparative | 1:0.002 | — | — | 1:3.69 |
| Preparation Example 3 | | | | |
| Comparative | 1:0.001 | 1:0.42 | 1:1.51 | 1:11.57 |
| Preparation Example 4 | | | | |
| Comparative | 1:0.001 | 1:0.69 | 1:0.66 | 1:12.58 |
| Preparation Example 5 | | | | |

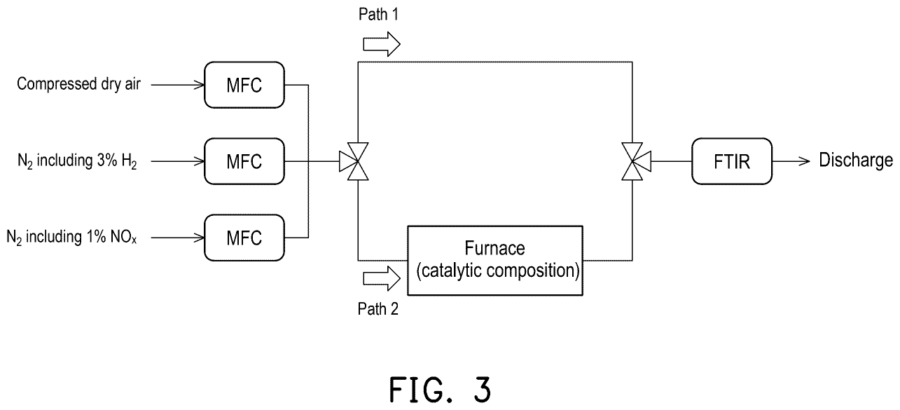

To verify destruction and removal efficiencies of the catalytic compositions, a device for removing nitrogen oxides was constructed. A block diagram of the device is shown in FIG. 3. In FIG. 3, the reactor (i.e., furnace) contains the catalytic composition, and the test gas is delivered to the furnace through a path 2 using a three-way valve. A Fourier transform infrared spectrometer (FTIR) was used to measure the NO_{X} concentration.

### Experimental Example 1

20 ml of the catalytic composition from Preparation Example 1 was placed in the furnace shown in FIG. 3. The temperature was controlled between 100° C. and 350° C. 1% NO_{X}, 3% H₂ (reducing agent), and compressed dry air (CDA) were separately introduced through mass flow controllers (MFC) to the three-way valve, mixed to form a total gas flow of 600 sccm. The gas hourly space velocity (GHSV) was approximately 1800 h⁻¹, the NO gas flow rate was approximately 360 ppm, and the NO₂ gas flow rate was approximately 240 ppm.

The NO_{X} concentration of the test gas was measured at two points: before destruction and removal (via a path 1 into the FTIR) and after destruction and removal (via the path 2 into the FTIR). The destruction and removal efficiency and selectivity were calculated based on the NO_{X} concentrations measured before and after destruction and removal and recorded in Table 3.

TABLE 3

| Reaction | | | |
|---|---|---|---|
| Temperature | DRE of NO | DRE of NO₂ | N₂ Selectivity |
| 100° C. | >99.6% | >98.1% | 84.8% |
| 150° C. | 97.5% | >98.1% | 82.2% |
| 200° C. | 91.3% | >98.1% | 81.0% |
| 250° C. | 87.5% | >98.1% | 93.6% |
| 300° C. | 67.8% | 92.3% | 97.8% |

In Table 3, a destruction and removal efficiency (DRE)=[1−(NO_{X} concentration via the path 2 into FTIR #NO_{X} concentration via the path 1 into FTIR)]×100%.

In Table 3, the N₂ selectivity=[Reacted NO_{X}−(generated byproducts×byproduct N equivalence)]÷reacted NO_{X}.

From Table 3, it may be observed that the catalytic composition of Preparation Example 1 achieved a NO₂ removal rate of over 98.1% at temperatures between 100° C. and 250° C., and a NO removal rate of over 87.5% at the same temperature range. The N₂ selectivity was greater than 80% in all cases.

### Experimental Example 2

The same equipment and parameters as in Experimental Example 1 were used, but the catalytic composition of Preparation Example 1 was replaced with the catalytic composition of Preparation Example 2. The results are shown in Table 4.

TABLE 4

| Reaction | | | |
|---|---|---|---|
| Temperature | DRE of NO | DRE of NO₂ | N₂ Selectivity |
| 100° C. | 96.5% | >97.7% | 83.5% |
| 150° C. | 95.6% | >97.7% | 82.3% |
| 200° C. | 84.0% | >97.7% | 92.6% |
| 250° C. | 89.2% | >97.7% | 95.9% |
| 300° C. | 74.2% | 89.9% | 96.6% |

From Table 4, it may be observed that the catalytic composition of Preparation Example 2 achieved a NO₂ removal rate of over 97.7% at temperatures between 100° C. and 250° C., and a NO removal rate of over 80% at the same temperature range. The N₂ selectivity was greater than 80% in all cases.

### Experimental Example 3

The same equipment and parameters as in Experimental Example 1 were used, but the catalytic composition of Preparation Example 1 was replaced with the catalytic composition of Preparation Example 3. The results are shown in Table 5.

TABLE 5

| Reaction | | | |
|---|---|---|---|
| Temperature | DRE of NO | DRE of NO₂ | N₂ Selectivity |
| 100° C. | 99.1% | >98.7% | 98.9% |
| 150° C. | >99.4% | >98.7% | 92.6% |
| 200° C. | 82.7% | >98.7% | 97.3% |

From Table 5, it may be observed that the catalytic composition of Preparation Example 3 achieved a NO₂ removal rate of over 98.7% and a NO removal rate of over 80% at temperatures between 100° C. and 200° C. The N₂ selectivity was greater than 90% in all cases.

### Experimental Example 4

The same equipment and parameters as in Experimental Example 1 were used, but the catalytic composition of Preparation Example 1 was replaced with the catalytic composition of Preparation Example 4. The results are shown in Table 6.

TABLE 6

| Reaction | | | |
|---|---|---|---|
| Temperature | DRE of NO | DRE of NO₂ | N₂ Selectivity |
| 100° C. | >99.5% | >98.2% | 81.1% |
| 150° C. | >99.5% | >98.2% | 81.5% |
| 200° C. | >99.5% | >98.2% | 82.9% |
| 250° C. | >99.5% | >98.2% | 94.3% |
| 300° C. | 88.2% | >98.2% | 99.9% |
| 350° C. | 55.6% | 80.6% | 99.5% |

From Table 6, it may be observed that the catalytic composition of Preparation Example 4 achieved a NO₂ removal rate of over 98.2% at temperatures between 100° C. and 300° C., and a NO removal rate of over 88.2% at the same temperature range. The N₂ selectivity was greater than 80% in all cases.

### Experimental Example 5

The same equipment and parameters as in Experimental Example 1 were used, but the catalytic composition of Preparation Example 1 was replaced with the catalytic composition of Preparation Example 5. The results are shown in Table 7.

TABLE 7

| Reaction | | | |
|---|---|---|---|
| Temperature | DRE of NO | DRE of NO₂ | N₂ Selectivity |
| 100° C. | >99.6% | >98.3% | 98.8% |
| 150° C. | >99.6% | >98.3% | 90.4% |
| 200° C. | >99.6% | >98.3% | 92.5% |

From Table 7, it may be observed that the catalytic composition of Preparation Example 5 achieved a NO₂ removal rate and a NO removal rate of over 98.3% at temperatures between 100° C. and 200° C. The N₂ selectivity was greater than 90% in all cases.

### Experimental Example 6

The same equipment and parameters as in Experimental Example 1 were used, but the catalytic composition of Preparation Example 1 was replaced with the catalytic composition of Preparation Example 6. The results are shown in Table 8.

TABLE 8

| Reaction | | | |
|---|---|---|---|
| Temperature | DRE of NO | DRE of NO₂ | N₂ Selectivity |
| 100° C. | >99.3% | >98.7% | 78.2% |
| 150° C. | >99.3% | >98.7% | 93.1% |
| 200° C. | >99.3% | >98.7% | 94.2% |
| 250° C. | >99.3% | >98.7% | 96.5% |
| 300° C. | >99.3% | >98.7% | 98.2% |
| 350° C. | 97.6% | 95.7% | 98.7% |

From Table 8, it may be observed that the catalytic composition of Preparation Example 6 achieved a NO₂ removal rate and a NO removal rate of over 95% at temperatures between 100° C. and 350° C. The N₂ selectivity was greater than 90% at temperatures between 150° C. and 350° C.

### Comparative Example 1

The same equipment and parameters as in Experimental Example 1 were used, but the catalytic composition of Preparation Example 1 was replaced with the catalytic composition of Comparative Preparation Example 2. The results are shown in Table 9.

TABLE 9

| Reaction | | | |
|---|---|---|---|
| Temperature | DRE of NO | DRE of NO₂ | N₂ Selectivity |
| 100° C. | 18.2% | 61.2% | 85.3% |
| 150° C. | 9.2% | 52.3% | 72.1% |
| 200° C. | 9.1% | 49.4% | 57.6% |
| 250° C. | 14.8% | 55.9% | 44.6% |
| 300° C. | 45.9% | 85.8% | 47.0% |

From Table 9, it may be observed that the catalytic composition of Comparative Preparation Example 2 exhibited poor NO_{X} DRE and unsatisfactory N₂ selectivity. Therefore, the absence of the third catalyst of second active component in the catalytic composition hindered the destruction and removal of nitrogen oxides.

### Comparative Example 2

The same equipment and parameters as in Experimental Example 1 were used, but the catalytic composition of Preparation Example 1 was replaced with the catalytic composition of Comparative Preparation Example 3. The results are shown in Table 10.

TABLE 10

| Reaction | | | |
|---|---|---|---|
| Temperature | DRE of NO | DRE of NO₂ | N₂ Selectivity |
| 100° C. | 13.2% | 6.4% | 98.5% |
| 150° C. | 15.9% | 7.6% | 98.7% |
| 200° C. | 5.3% | <5% | N.A. |
| 250° C. | <5% | <5% | N.A. |
| 300° C. | 31.4% | <5% | N.A. |
| 350° C. | 37.1% | <5% | N.A. |

From Table 10, it may be observed that the catalytic composition of Comparative Preparation Example 3 exhibited very poor NO_{X} DRE, and no N₂ selectivity was observed at temperatures above 200° C. Therefore, the absence of the third catalyst of second active component in the catalytic composition hindered the destruction and removal of nitrogen oxides.

### Comparative Example 3

The same equipment and parameters as in Experimental Example 1 were used, but the catalytic composition of Preparation Example 1 was replaced with the catalytic composition of Comparative Preparation Example 4. The results are shown in Table 11.

TABLE 11

| Reaction | | | |
|---|---|---|---|
| Temperature | DRE of NO | DRE of NO₂ | N₂ Selectivity |
| 100° C. | 25.1% | 67.8% | 46.3% |
| 150° C. | 32.9% | 78.3% | 12.5% |
| 200° C. | 34.2% | 83.8% | 11.8% |
| 250° C. | 40.2% | 85.5% | 11.5% |
| 300° C. | 36.1% | 80.3% | 46.3% |

From Table 11, it may be observed that the catalytic composition of Comparative Preparation Example 4 exhibited poor NO_{X} DRE and very poor N₂ selectivity. Therefore, substituting the third catalyst of the second active component in the catalytic composition with other metal oxides similarly hindered the destruction and removal of nitrogen oxides.

### Comparative Example 4

The same equipment and parameters as in Experimental Example 1 were used, but the catalytic composition of Preparation Example 1 was replaced with the catalytic composition of Comparative Preparation Example 5. The results are shown in Table 12.

TABLE 12

| Reaction | | | |
|---|---|---|---|
| Temperature | DRE of NO | DRE of NO₂ | N₂ Selectivity |
| 100° C. | <5% | 26.6% | 87.9% |
| 150° C. | 5.2% | 30.9% | 35.6% |
| 200° C. | 44.8% | 83.1% | 72.9% |
| 250° C. | 80.8% | >96.4% | 72.3% |
| 300° C. | 60.1% | 94.0% | 32.4% |
| 350° C. | 38.1% | 83.6% | 26.2% |

From Table 12, it may be observed that the catalytic composition of Comparative Preparation Example 5 exhibited poor NO_{X} DRE, especially at low reaction temperatures. The N₂ selectivity was also unsatisfactory. Therefore, if the first active component of the catalytic composition does not include manganese oxide, the destruction and removal of nitrogen oxides will be hindered.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A catalytic composition, comprising:
a carrier;
a first active component, covering a surface of the carrier, wherein the first active component comprises a first catalyst, and the first catalyst is a manganese oxide; and
a second active component, comprising a second catalyst and a third catalyst, the second active component covering a surface of the first active component and a surface of the carrier uncovered with the first active component, wherein the second catalyst comprises a platinum metal, a palladium metal, or a combination thereof, and the third catalyst comprises a potassium oxide, a sodium oxide, or a combination thereof, wherein
a molar ratio of the first catalyst to the second catalyst is from 1:0.001 to 1:0.2, and a molar ratio of the first catalyst to the third catalyst is from 1:0.1 to 1:10.

2. The catalytic composition according to claim 1, wherein the first active component further comprises a fourth catalyst, and the fourth catalyst comprises a copper oxide, a nickel oxide, or a combination thereof.

3. The catalytic composition according to claim 2, wherein a molar ratio of the first catalyst to the fourth catalyst is from 1:0.1 to 1:10.

4. The catalytic composition according to claim 1, wherein a molar ratio of the first catalyst to the carrier is from 1:3 to 1:20.

5. The catalytic composition according to claim 1, wherein the carrier comprises an aluminum oxide, a titanium oxide, a zirconium oxide, a cerium oxide, a magnesium oxide, or a combination thereof.

6. The catalytic composition according to claim 1, wherein a Brunauer-Emmett-Teller surface area of the catalytic composition is from 140 m² g⁻¹ to 500 m² g⁻¹.

7. The catalytic composition according to claim 1, wherein a particle diameter of the catalytic composition is from 100 μm to 10 mm.

8. A method for removing a nitrogen oxide, comprising performing a selective catalytic reduction with a hydrogen on the nitrogen oxide using the catalytic composition according to claim 1.

9. The method for removing the nitrogen oxide according to claim 8, wherein a removal rate of the nitrogen oxide is greater than 90%.

10. The method for removing the nitrogen oxide according to claim 8, wherein the selective catalytic reduction with the hydrogen is performed at a temperature of from 100° C. to 250° C.
